(19) United States
(12) Patent Application Publication
(10) Pub. No.: US 2012/0099712 A1
(43) Pub. Date: Apr. 26, 2012

(54) Computer-Based Method of Generating a Unique Non-Repeating Sequence Number

(76) Inventor: Ricky Olivarez, Diamond Bar, CA (US)

(21) Appl. No.: 13/084,474

(22) Filed: Apr. 11, 2011

Related U.S. Application Data
(60) Provisional application No. 61/405,564, filed on Oct. 21, 2010.

(51) Int. Cl. H04M 11/04

(52) U.S. Cl. 379/45

(57) ABSTRACT

The present invention is a method and system for generating a unique, non-repeating, and sequential number. Specifically, the invention is a computer-aided system, method, and product that generates a unique, non-repeating, and non-overlapping sequence number for emergency medical services providers that is independent of the initial provider. The numbering system allows emergency medical service providers to continue to use their existing incident report generating system, but provides them with a unique incident number to connect to the report that does not overlap with other unique incident numbers generated by other emergency medical service providers.

### CROSS-REFERENCE TO RELATED APPLICATIONS

Priority is claimed to U.S. Provisional Patent Application No. 61/405,564, filed on Oct. 21, 2010, titled: “A method for the creation of a sequence number that is independent of the EMS provider using it, and never repeats,” by inventor Ricardo Olivarez, the contents of which are expressly incorporated herein by this reference.

### FIELD OF INVENTION

This invention generally relates to a system and method for generating a non-repeatable sequence number. Moreover, it pertains specifically to a computer-aided system and method that generates a unique non-repeatable sequence incident number for emergency medical services providers that is independent of the providing entities generating the number.

### BACKGROUND

Sequential numbering allows a single entity, unit, or organization to generate a sequential number to a product, customer, person, document, or task. Because only a single entity is generating the sequential numbers, the numbers are generally unique to the product, customer, person, document, or task. Sequential number generating systems are well known in the prior art, because just about every business and government agency uses identifiers to track what they do. Emergency medical services providers and responders are no exception.

Each time an emergency medical services provider treats or initially triages a sick or injured patient, the provider creates an report, which has an incident number that is then associated with that patient. Although the emergency medical services provider's number might be unique to the particular unit and provider, when the number is ultimately entered into a hospital database, department of health services database, or the National EMS Information System (NEMSIS), the number might very well overlap with other numbers generated by other units or providers. Indeed, in large metropolitan area, there might be dozens, or even hundreds of emergency medical services providers, so the chance of having overlapping numbers is very high. Unfortunately, this overlap has the chance to lead to confusion between patients, misdiagnosis, and/or faulty reporting and data gathering. Thus, what is needed is a method and system of generating a unique, non-repeating sequence number for emergency medical services provider that is independent of the initiating provider and that prevents substantial overlap from numbers generated by other emergency medical service providers.

Regarding references that disclose non-repeating sequence numbers, the United States Patent and Trademark Office (USPTO) itself provides an example of sequential numbering systems that attaches a unique sequential alphanumeric number identifier to a document or task. Specifically, the USPTO assigns each patent application a unique application Number, Publication Number (if or when Published), and patent Number (if or when granted).

The USPTO's publication numbering system is an example of a system that incorporates two sequential numbers to create a single unique sequential number. The first sequential number used in the USPTO's publication numbering system is the four digit year in which the application publishes. The second number is a seven digit number that starts at “0000001” with the first application to publish in any given year and goes sequentially upward from there. Thus, the first U.S. Published Patent Application in 2006 was assigned identification number 20060000001, which was filed by Chilton on a “Phototherapy Eyeshield For Babies.” This numbering system results in each U.S. Published Patent Application having a unique number that will never be repeated.

The problem with single or even double sequential numbering systems is that they are only unique to the entity that created them and the number generated might overlap with numbers generated by a similar entity or organization who is numbering documents in a similar manner. For example, although the identification number 20060000001 might be unique to one organization, it might not be unique when compared to document or case numbers from similar entities, which might be using a similar numbering system.

It is also well known in the art to include non-sequential alphanumeric codes, such as alpha initials or pre-determined entity code to a sequential and non-repeating number, in order to further identify the source of the sequential number or set of numbers. But, this solution results merely in two or more sets of numbers that are almost certain to have overlapping sequential numbers that only differ in their organization code. An example of adding alpha initials or a preset code to demarcate what would be two very similar numbers sets is the various State Driver's License Agencies, which a two digit State code to identify in what State the license was issued. Without the alpha initials or preset code added to a driver's license, it is conceivable that fifty (50) people might have the same driver's license number.

For purposes of efficiently and effectively treating, triaging, and tracking an injured/sick person or patient through the medical system from first responder to primary treating hospital, it is important that the identification number assigned to the person be unique, non-repeating, non-overlapping, and reflect who the first responder was and what unit treated the patient. Thus, the mere addition of a simple organization code to a simple sequentially generated number is not an acceptable solution to providing a non-repeating and unique sequential number. Further, a substantial portion of the number would still have a high likelihood of overlapping with another number.

Before the system and method of the present invention there was no computer-based system or method of generating a unique, non-repeating sequence number for emergency medical services providers that is independent of the initial provider.

### SUMMARY OF THE INVENTION

To minimize the limitations in the prior art, and to minimize other limitations that will become apparent upon reading and understanding the present specification, the present invention discloses a method and system for generating a unique, non-repeating, and sequential number. Moreover, it pertains specifically to a computer-aided system, method, and product that generates a unique, non-repeating sequence number for emergency medical services providers that is independent of the initial provider.

One embodiment of the present invention is a computer-based method of generating a unique identification number, that may comprise the steps of: providing one or more electronic data processing units; providing a plurality of entities; generating one or more unique identification numbers by one entity of the entities within the electronic data processing units; wherein the unique identification numbers are comprised of a plurality of sub-portion identifiers; wherein there are at least three or more sub-portion identifiers; wherein the sub-portion identifiers are comprised of an entity code, a date code, and a sequence number; assigning a unique entity code to each of the entities such that a plurality of entity codes are created; selecting by the electronic data processing units the entity code based on which one entity of the entities is using the electronic data processing units to generate the unique identification numbers; selecting by the electronic data processing units the date code; wherein the date code is based on a date on which the unique identification numbers are generated; selecting by the electronic data processing units the sequence number; wherein the sequence number is based on how many of the unique identification numbers have been generated that day by the unit using the electronic data processing units to generate the unique identification numbers; wherein the unique identification numbers do not repeat and do not overlap.

Preferably, the sub-portion identifiers are further comprised of a unit code. Each of the entities may be comprised of a plurality of units. The method may further comprise the steps of: assigning a unique unit code to each of the units such that a plurality of unit codes are created; and selecting by the electronic data processing units the unit code based on which one unit is using the electronic data processing units to generate the unique identification numbers. The unit code is preferably comprised of one or more alphabetical letters. The sub-portion identifiers are preferably further comprised of a unit number and the method preferably includes the step of assigning a unique unit number to each of the units such that a plurality of unit numbers is created. The unit number is preferably comprised of one or more single digit numbers. The method of generating a unique identification number may further comprise the step of selecting by the electronic data processing units the unit number based on which one unit is using the electronic data processing units to generate the unique identification numbers. Preferably, the entity codes are comprised of one to five alphanumeric characters. The unique identification numbers are preferably generated in connection with the preparation of one or more emergency medical service incident reports, the entities are preferably emergency medical services providers, and the units are operational units of the emergency medical services providers.

Another embodiment of the invention is a computer-based method of generating a unique identification number, the unique identification number being associated with an emergency medical services incident report, which may comprise the steps of: providing one or more electronic data processing units; providing a plurality of entities; wherein the entities are emergency medical services providers; generating one or more unique identification numbers by the entities within the electronic data processing units; wherein the unique identification numbers are generated in connection with the preparation of an emergency medical services incident report; wherein the unique identification numbers are comprised of a plurality of sub-portion identifiers; wherein the sub-portion identifiers are comprised of an entity code, a unit code, a unit number, a year code, a day of the year code, and a sequence number; assigning a unique entity code to each of the entities such that a plurality of entity codes are created; wherein the entity codes are comprised of one to five alphabetical letters; selecting by the electronic data processing units the entity code based on which one entity of the entities is using the electronic data processing units to generate the unique identification numbers; wherein each of the entities is comprised of a plurality of units; wherein the units are operational units of the emergency medical services providers; assigning a unique unit code to each of the units such that a plurality of unit codes are created; wherein the unit code is comprised of one to three alphabetical letters; selecting by the electronic data processing units the unit code based on which one unit is using the electronic data processing units to generate the unique identification numbers; assigning a unique unit number to each of the units such that a plurality of unit numbers are created; wherein the unit number is comprised of one to three single digit numbers; selecting by the electronic data processing units the unit number based on which one unit is using the electronic data processing units to generate the unique identification numbers; selecting by the electronic data processing units the year code; wherein the year code is based on a final two digits of the year; selecting by the electronic data processing units the day of the year code; wherein the day of the year code is based on how many days have passed since the beginning of the current year; selecting by the electronic data processing units the sequence number; wherein the sequence number is based on how many of the unique identification numbers have been generated that day by the unit using the electronic data processing units; wherein the unique identification numbers do not repeat and do not overlap.

Another embodiment of the invention is a computer-based method of generating a unique identification number, the unique identification number being associated with an emergency medical services incident report may comprise the steps of: providing one or more electronic data processing units; providing a plurality of entities; wherein the entities are emergency medical services providers; generating one or more unique identification numbers by one entity of the entities within the electronic data processing units; wherein the unique identification numbers are generated in connection with the preparation of one or more emergency medical service incident reports; wherein the unique identification numbers are comprised of a plurality of sub-portion identifiers; wherein there are at least three or more sub-portion identifiers; wherein the sub-portion identifiers are comprised of an entity code, a date code, and a sequence number; assigning a unique entity code to each of the entities such that a plurality of entity codes are created; selecting by the electronic data processing units the entity code based on which one entity of the entities is using the electronic data processing units to generate the unique identification numbers; selecting by the electronic data processing units the date code; wherein the date code is based on a date on which the unique identification numbers are generated; selecting by the electronic data processing units the sequence number; wherein the sequence number is based on how many of the unique identification numbers have been generated that day by the unit using the electronic data processing units to generate the unique identification numbers; wherein the unique identification numbers do not repeat and do not overlap.

The sub-portion identifiers are preferably further comprised of a unit code, wherein each of the entities may be comprised of a plurality of units and the units are preferably operational units of the emergency medical services providers. The method preferably includes the steps of assigning a unique unit code to each of the units such that a plurality of unit codes are created and selecting by the electronic data processing units the unit code based on which one unit is using the electronic data processing units to generate the unique identification numbers. The unit code is preferably comprised of one or more alphabetical letters. Preferably, the sub-portion identifiers are further comprised of a unit number. The method preferably includes the steps of: assigning a unique unit number to each of the units such that a plurality of unit numbers are created and selecting by the electronic data processing units the unit number based on which one unit is using the electronic data processing units to generate the unique identification numbers, wherein the unit number is comprised of one or more single digit numbers. The entity codes are preferably comprised of one to five alphanumeric characters. It is also preferred that the date code is comprised of a year code and a day of the year code. The computer-based method of generating a unique identification number preferably further comprises the steps of: selecting by the electronic data processing units the year code; wherein the year code is based on a final two digits of the common era year; selecting by the electronic data processing units the year code; wherein the year code is based on a final two digits of the common era year.

It is an object of the present invention to provide a method and system for generating a unique identifier or identification number that overcomes the limitations of the prior art.

It is an object of the present invention to provide a unique identification number for an emergency medical services incident report. The unique identification number is comprised of several sub-parts or sub-identifiers that are combined to produce a unique sequence number. This unique sequence number is easily broken down to its constituent parts. A review of the constituent parts provides a wealth of information regarding when the incident occurred and who first filed out the incident report.

It is an object of the present invention to provide a unique identifier that can be used in any healthcare setting or any field or occupation that requires a unique, non-repeating, non-overlapping sequenced identification number.

The method and system for generating a unique identifier or identification number is independent of the emergency medical services provider using the system.

Other features and advantages are inherent in the system, method, and product claimed and disclosed will become apparent to those skilled in the art from the following detailed description and its accompanying drawings.

### BRIEF DESCRIPTION OF THE DRAWINGS

FIG. 1 is a flow-chart diagram of another embodiment of the present invention.

FIG. 2 is a flow-chart diagram of the steps of the method of one embodiment of the present invention.

FIG. 3 is a continuation of the flow-chart diagram of FIG. 2 showing the steps of the method of one embodiment of the present invention.

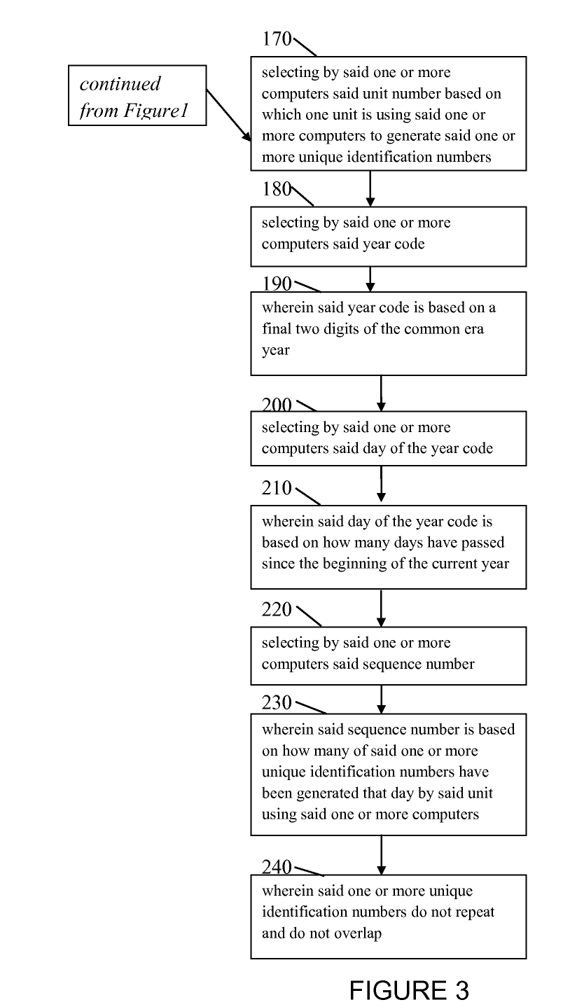

### DETAILED DESCRIPTIONS OF THE DRAWINGS

In the following detailed description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

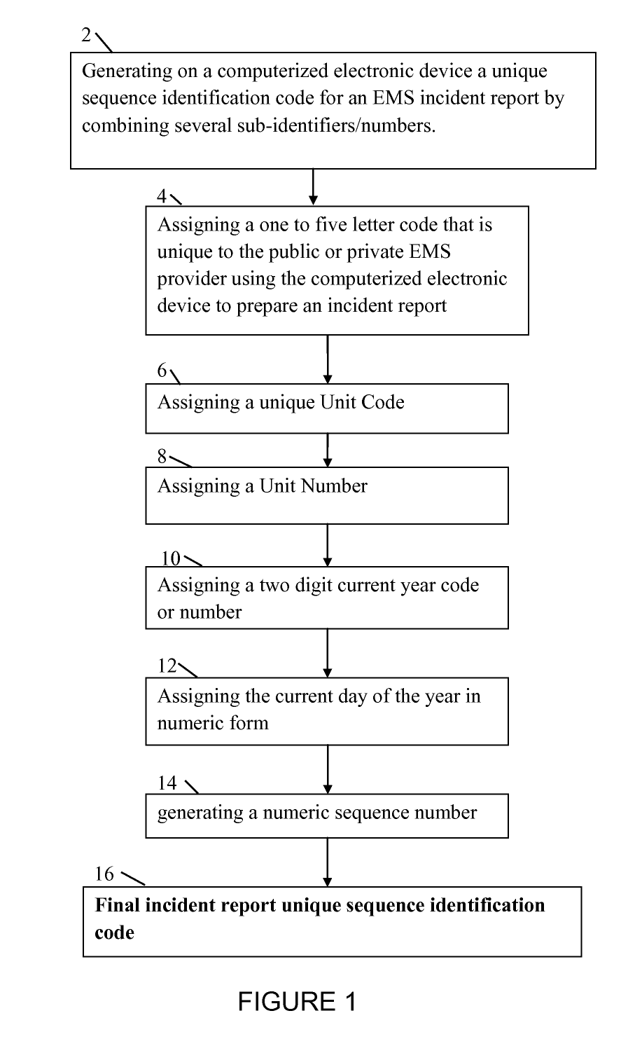

FIG. 1 is a flow-chart diagram of another embodiment of the present invention. FIG. 1 shows a preferred embodiment of the invention wherein the sequence number created is preferably created for an emergency medical service(s) (hereinafter “EMS”) provider incident report. The sequence number is preferably created by combining several sub-portion identifiers, codes, or numbers, including, but not limited to: generating on a computerized electronic device a unique sequence identification code for an EMS incident report by combining several sub-identifiers/numbers 2; assigning a one to five letter code that is unique to the public or private EMS provider using the computerized electronic device to prepare an incident report 4; assigning a unique Unit Code 6; assigning a Unit Number 8; assigning a two digit current year code or number 10; assigning the current day of the year in numeric form 12; and generating a numeric sequence number 14. The result is a final incident report unique sequence identification code (or number) 16 that can be easily broken down into its constituent parts. The one to five letter code, from the step of assigning a one to five letter code that is unique to the public or private EMS provider using the computerized electronic device to prepare an incident report 4, is an entity code that is set depending on what entity is preparing the incident report. The entity code may be relevant to the entire country or it may be regional. The unit code and unit number are specific to the operational unit using the computerized electronic device to prepare the incident report. The entity codes and unit code and number are preferably preset within the computerized electronic device and are thus populated automatically, but they may be generated and assigned by the computer at the time of preparing the report. Although the Unit Code 6; and Unit Number 8 are preferably 1-3 characters, they, and any other sub-portion may be any number of characters without deviating from the scope of the invention.

The two digit current year code or number 10 is preferably the last two digits of the four digit year. The day of the year code 12 simply starts at “1” on January 1st and ends at “365” (or “366” in a leap year) on December 31st. In other words, the day of the year code reflects the date on which the incident report is taken. The numeric sequence number 14 preferably starts at “1” with the first incident report of the day (based on a 24 hours day starting at midnight). The numbers simply go up sequentially from “1” and then start over the next day.

Although a specific order of the sub-portion identifiers is shown, the sub-portion identifiers may be in any order without deviating from the scope of the invention. Further, additional sub-portion identifiers may be included and included sub-portion identifiers may be left out of the final identification number. Further, the order of the sub-portions may be modified depending on the needs of the EMS agencies generating the number for the request. For example, the generating agency may desire to have the 1-4 letter code to come first or last. Importantly, any sub-portion of the unique sequence identification code may be a mix of letters, numbers, or other characters.

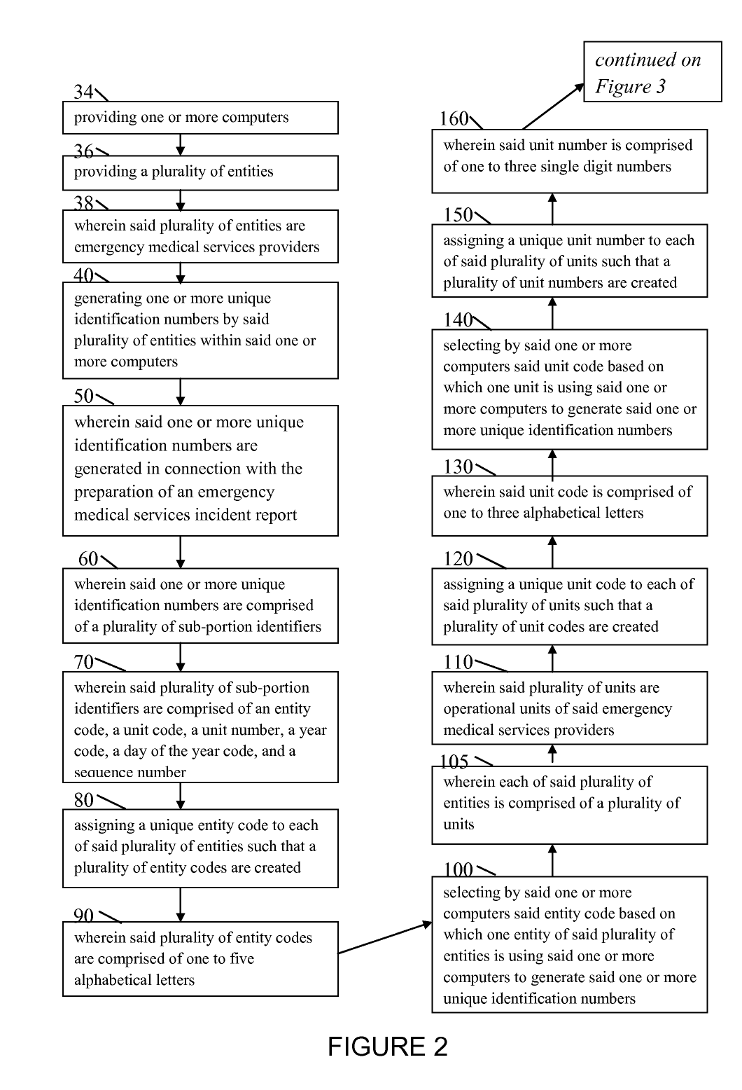

FIG. 2 is a flow-chart diagram of the steps of the method of one embodiment of the present invention. As shown in FIG. 2, the present invention is preferably a computer-based method of generating a unique identification number, the unique identification number being associated with an emergency medical services incident report, comprising a series of steps. The first step is providing one or more electronic data processing units 34. The computer(s) is the machine that generates the sequence number and then associates it with an emergency medical services incident report. The computer is preferably a dedicated computerized electronic device or tablet computer on which the emergency medical services form application is loaded. When a new incident report is created, the computerized electronic device (or computer) generates a unique identification number. The second step is providing a plurality of entities 36. The plurality of entities is preferably emergency medical services providers 38. The invention is designed to be used by multiple entities to ensure that the incident reports generated by the disparate entities are able to be integrated and do not overlap across entities. The next step is generating one or more unique identification numbers by the plurality of entities within the one or more electronic data processing units 40. The unique identification numbers are generated in connection with the preparation of an emergency medical services incident report 50 and they are comprised of a plurality of sub-portion identifiers 60.

The sub-portion identifiers are comprised of an entity code, a unit code, a unit number, a year code, a day of the year code, and a sequence number 70. These five sub-portion identifiers are combined in order to create the unique sequence identifier. In order to have the entity code, the method includes the step of assigning a unique entity code to each of the plurality of entities such that a plurality of entity codes is created 80. Preferably, the entity codes are comprised of one to five (1-5) alphabetical letters 90 (but numbers or a combination of alpha and numeric may be used, and any number of characters may be included). Next, the computer performs the step of selecting by the one or more electronic data processing units the entity code based on which one entity of the plurality of entities is using the one or more electronic data processing units to generate the one or more unique identification numbers 100. Each of the plurality of entities might be comprised of a plurality of units 105 (which might be operational units of the emergency medical services providers 110 or individual user). The computer assigns a unique unit code to each of the plurality of units such that a plurality of unit codes is created 120. The unit code is comprised of one to three alphabetical letters 130. The unit code is selected based on which one unit is using the one or more electronic data processing units to generate the one or more unique identification numbers 140. In addition to a unit code being assigned and selected, it is preferred that the computer assign a unique unit number to each of the plurality of units such that a plurality of unit numbers are created 150. The unit number is comprised of one to three single digit numbers 160.

FIG. 2 is a continuation of the flow-chart diagram of FIG. 2 showing the steps of the method of one embodiment of the present invention. The next step in the method is selecting by the one or more electronic data processing units the unit number based on which one unit is using the one or more electronic data processing units to generate the one or more unique identification numbers 170. The entity code and unit codes are specific to the users and quickly identify to all who review the number what entity and unit imitated the incident report. The next two sub-portions of the unique sequence number are based on the year and day or date. Specifically, selecting by the one or more electronic data processing units the year code 180. The year code is based on a final two digits of the year 190. Next, selecting by the one or more electronic data processing units the day of the year code 200. The day of the year code is based on how many days have passed since the beginning of the current year 210.

The final step of generating the number is selecting by the one or more electronic data processing units the sequence number 220. The sequence number is based on how many of the one or more unique identification numbers have been generated that day by the unit using the one or more electronic data processing units 230. The one or more unique identification numbers do not repeat and do not overlap 240.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A computer-based method of generating a unique identification number, comprising steps of:
providing one or more electronic data processing units;
providing a plurality of entities;
generating one or more unique identification numbers by one entity of said plurality of entities within said one or more electronic data processing units;
wherein said one or more unique identification numbers are comprised of a plurality of sub-portion identifiers;
wherein there are at least three or more sub-portion identifiers;
wherein said plurality of sub-portion identifiers are comprised of an entity code, a date code, and a sequence number;
assigning a unique entity code to each of said plurality of entities such that a plurality of entity codes are created;
selecting by said one or more electronic data processing units said entity code based on which one entity of said plurality of entities is using said one or more electronic data processing units to generate said one or more unique identification numbers;
selecting by said one or more electronic data processing units said date code;
wherein said date code is based on a date on which said one or more unique identification numbers are generated;
selecting by said one or more electronic data processing units said sequence number;
wherein said sequence number is based on how many of said one or more unique identification numbers have been generated that day by a unit using said one or more electronic data processing units to generate said one or more unique identification numbers;
wherein said one or more unique identification numbers do not repeat and do not overlap.

2. The computer-based method of generating a unique identification number of claim 1, wherein said plurality of sub-portion identifiers are further comprised of a unit code;
wherein each of said plurality of entities is comprised of a plurality of units;
assigning a unique unit code to each of said plurality of units such that a plurality of unit codes are created;
selecting by said one or more electronic data processing units said unit code based on which one unit is using said one or more electronic data processing units to generate said one or more unique identification numbers.

3. The computer-based method of generating a unique identification number of claim 2, wherein said unit code is comprised of one or more alphabetical letters.

4. The computer-based method of generating a unique identification number of claim 3, wherein said plurality of sub-portion identifiers are further comprised of a unit number;
assigning a unique unit number to each of said plurality of units such that a plurality of unit numbers are created;
wherein said unit number is comprised of one or more single digit numbers;
selecting by said one or more electronic data processing units said unit number based on which one unit is using said one or more electronic data processing units to generate said one or more unique identification numbers.

5. The computer-based method of generating a unique identification number of claim 4, wherein said plurality of entity codes are comprised of one to five alphanumeric characters.

6. The computer-based method of generating a unique identification number of claim 5, wherein said one or more unique identification numbers are generated in connection with the preparation of one or more emergency medical service incident reports.

7. The computer-based method of generating a unique identification number of claim 6, wherein said plurality of entities are emergency medical services providers; and
wherein said plurality of units are operational units of said emergency medical services providers.

8. The computer-based method of generating a unique identification number of claim 1, wherein said one or more unique identification numbers are generated in connection with the preparation of one or more emergency medical service incident reports;
wherein said plurality of entities are emergency medical services providers.

9. A computer-based method of generating a unique identification number, the unique identification number being associated with an emergency medical services incident report, comprising steps of:
providing one or more electronic data processing units;
providing a plurality of entities;
wherein said plurality of entities are emergency medical services providers;
generating one or more unique identification numbers by said plurality of entities within said one or more electronic data processing units;
wherein said one or more unique identification numbers are generated in connection with the preparation of an emergency medical services incident report;
wherein said one or more unique identification numbers are comprised of a plurality of sub-portion identifiers;
wherein said plurality of sub-portion identifiers are comprised of an entity code, a unit code, a unit number, a year code, a day of the year code, and a sequence number;
assigning a unique entity code to each of said plurality of entities such that a plurality of entity codes are created;
wherein said plurality of entity codes are comprised of one to five alphabetical letters;
selecting by said one or more electronic data processing units said entity code based on which one entity of said plurality of entities is using said one or more electronic data processing units to generate said one or more unique identification numbers;
wherein each of said plurality of entities is comprised of a plurality of units;
wherein said plurality of units are operational units of said emergency medical services providers;
assigning a unique unit code to each of said plurality of units such that a plurality of unit codes are created;
wherein said unit code is comprised of one to three alphabetical letters;
selecting by said one or more electronic data processing units said unit code based on which one unit is using said one or more electronic data processing units to generate said one or more unique identification numbers;
assigning a unique unit number to each of said plurality of units such that a plurality of unit numbers are created;
wherein said unit number is comprised of one to three single digit numbers;
selecting by said one or more electronic data processing units said unit number based on which one unit is using said one or more electronic data processing units to generate said one or more unique identification numbers;
selecting by said one or more electronic data processing units said year code;
wherein said year code is based on a final two digits of the year;
selecting by said one or more electronic data processing units said day of the year code;
wherein said day of the year code is based on how many days have passed since the beginning of the current year;
selecting by said one or more electronic data processing units said sequence number;
wherein said sequence number is based on how many of said one or more unique identification numbers have been generated that day by said unit using said one or more electronic data processing units;
wherein said one or more unique identification numbers do not repeat and do not overlap.

10. A computer-based method of generating a unique identification number, the unique identification number being associated with an emergency medical services incident report, comprising steps of:
providing one or more electronic data processing units;
providing a plurality of entities;
wherein said plurality of entities are emergency medical services providers;
generating one or more unique identification numbers by one entity of said plurality of entities within said one or more electronic data processing units;
wherein said one or more unique identification numbers are generated in connection with the preparation of one or more emergency medical service incident reports;
wherein said one or more unique identification numbers are comprised of a plurality of sub-portion identifiers;
wherein there are at least three or more sub-portion identifiers;
wherein said plurality of sub-portion identifiers are comprised of an entity code, a date code, and a sequence number;
assigning a unique entity code to each of said plurality of entities such that a plurality of entity codes are created;
selecting by said one or more electronic data processing units said entity code based on which one entity of said plurality of entities is using said one or more electronic data processing units to generate said one or more unique identification numbers;
selecting by said one or more electronic data processing units said date code;
wherein said date code is based on a date on which said one or more unique identification numbers are generated;
selecting by said one or more electronic data processing units said sequence number;
wherein said sequence number is based on how many of said one or more unique identification numbers have been generated that day by a unit using said one or more electronic data processing units to generate said one or more unique identification numbers;
wherein said one or more unique identification numbers do not repeat and do not overlap.

11. The computer-based method of generating a unique identification number of claim 10, wherein said plurality of sub-portion identifiers are further comprised of a unit code;
wherein each of said plurality of entities is comprised of a plurality of units;
wherein said plurality of units are operational units of said emergency medical services providers;
assigning a unique unit code to each of said plurality of units such that a plurality of unit codes are created;
selecting by said one or more electronic data processing units said unit code based on which one unit is using said one or more electronic data processing units to generate said one or more unique identification numbers.

12. The computer-based method of generating a unique identification number of claim 11, wherein said unit code is comprised of one or more alphabetical letters.

13. The computer-based method of generating a unique identification number of claim 12, wherein said plurality of sub-portion identifiers are further comprised of a unit number;
assigning a unique unit number to each of said plurality of units such that a plurality of unit numbers are created;
wherein said unit number is comprised of one or more single digit numbers;
selecting by said one or more electronic data processing units said unit number based on which one unit is using said one or more electronic data processing units to generate said one or more unique identification numbers.

14. The computer-based method of generating a unique identification number of claim 13, wherein said plurality of entity codes are comprised of one to five alphanumeric characters.

15. The computer-based method of generating a unique identification number of claim 14, wherein said date code is comprised of a year code and a day of the year code.

16. The computer-based method of generating a unique identification number of claim 15, further comprising the steps of:
selecting by said one or more electronic data processing units said year code;
wherein said year code is based on a final two digits of the year.

17. The computer-based method of generating a unique identification number of claim 16, further comprising the steps of:
selecting by said one or more electronic data processing units said year code;
wherein said year code is based on a final two digits of the year.

18. The computer-based method of generating a unique identification number of claim 10, wherein said date code is comprised of a year code and a day of the year code.

19. The computer-based method of generating a unique identification number of claim 18, further comprising the steps of:
selecting by said one or more electronic data processing units said year code;
wherein said year code is based on a final two digits of the year.

20. The computer-based method of generating a unique identification number of claim 19, further comprising the steps of:
selecting by said one or more electronic data processing units said day of the year code;
wherein said day of the year code is based on how many days have passed since the beginning of the current year.
